(19) United States
(12) Patent Application Publication
(10) Pub. No.: US 2005/0219945 A1
(43) Pub. Date: Oct. 6, 2005

(54) Closed automatic fluid mixing system

(75) Inventors: Milton I. Kelley, Cypress, TX (US); Blake C. Burnette, Spring, TX (US); Bradley T. Carlson, Cypress, TX (US)

Correspondence Address: WILLIAMS, MORGAN & AMERSON, P.C., 10333 RICHMOND, SUITE 1100, HOUSTON, TX, 77042, US

(73) Assignee: BJ Services Company

(21) Appl. No.: 11/138,231

(22) Filed: May 26, 2005

Related U.S. Application Data
(63) Continuation of application No. 10/331,719, filed on Dec. 30, 2002, now abandoned.

(51) Int. Cl. B01F 15/02

(52) U.S. Cl. 366/142; 366/152.1; 366/160.2; 366/181.8; 366/182.2; 366/182.4

(57) ABSTRACT

A closed automatic fluid mixing apparatus and method for mixing two fluids while maintaining a feed pressure of the mixed fluid at a predetermined level are disclosed. The apparatus comprises a first fluid feed, a second fluid feed, a mixing valve, and a closed control system. The mixing valve is capable of mixing a first fluid received from the first fluid feed and a second fluid received from the second fluid feed to produce a mixed fluid. The closed control system is capable of controlling the mixing valve to determine the ratio of the first and second fluids in the mixed fluid while maintaining the pressure of the mixed fluid at a predetermined level. The method comprises feeding a first fluid and a second fluid to a mixing valve; mixing the first and second fluids therein; and controlling the mixing valve's actuation of to determine the ratio of the first and second fluids in a resultant mixed fluid while maintaining the pressure of the mixed fluid at a predetermined level.

### BACKGROUND OF THE INVENTION

1. Field of the Invention

The present invention pertains to a closed automatic fluid mixing system, and, more particularly, to a closed automatic fluid mixing system capable of mixing two fluids while maintaining a feed pressure of the mixed fluid at a predetermined level.

2. Description of the Related Art

Wells drilled in exploration or for production of hydrocarbons typically employ fluids pumped at relatively high pressures down the bore of the well. A variety of fluids are used for a variety of purposes. The fluids will frequently comprise several components that are mixed at the site of the well. The component fluids are typically transported to the site and stored in separate holding tanks. The component fluids are then fed into a mixing tank, where they are mixed in the desired ratio for the anticipated application. The mixed fluid is then fed to a positive displacement pump, which pumps the fluid down the well bore. Positive displacement pumps, as opposed to centrifugal pumps, are used because of the relatively high (up to 15,000 psi) pressures employed.

Although this system has worked satisfactorily for many years, it presents many problems. The mixing tanks can be relatively expensive—up to $50,000 each—and can occupy space at the site that is literally and/or figuratively costly. The fluids are frequently highly acidic, and so the mixing tank sometimes creates environmental and safety concerns. For instance, if a job is cut short, the mixed fluid remaining in the mixing tank must be disposed of, which may implicate compliance with environmental regulations in some circumstances.

These drawbacks are tolerated, however, because of the needs of the positive displacement pump. A positive displacement pump includes one or more pistons, frequently as many as three to five, that reciprocate. As the piston(s) reciprocate, fluid is drawn into the pump's inlet and pumped out. If the supply of fluid to the pump is interrupted, the pump will “cavitate.” Persistent cavitation can produce effects in the pump that can damage or even destroy the pump. The mixing tank, however, will hold a supply of feed fluid whose level can be monitored to avoid cavitating the pump.

The present invention is directed to resolving, or at least reducing, one or all of the problems mentioned above.

### SUMMARY OF THE INVENTION

A closed automatic fluid mixing apparatus and method for mixing two fluids while maintaining a feed pressure of the mixed fluid at a predetermined level are disclosed. The apparatus comprises a first fluid feed, a second fluid feed, a mixing valve, and a closed control system. The mixing valve is capable of mixing a first fluid received from the first fluid feed and a second fluid received from the second fluid feed to produce a mixed fluid. The closed control system is capable of controlling the mixing valve to determine the ratio of the first and second fluids in the mixed fluid while maintaining the pressure of the mixed fluid at a predetermined level. The method, comprises feeding a first fluid to a mixing valve; feeding a second fluid to the mixing valve; mixing the first and second fluids in the mixing valve; and controlling the actuation of the mixing valve to determine the ratio of the first and second fluids in a resultant mixed fluid while maintaining the pressure of the mixed fluid at a predetermined level.

### BRIEF DESCRIPTION OF THE DRAWINGS

The invention may be understood by reference to the following description taken in conjunction with the accompanying drawings, in which like reference numerals identify like elements, and in which:

FIG. 1 is a functional block diagram of one particular embodiment of the present invention;

FIG. 2 is a flow diagram for the control of the closed loop mixing system in an embodiment where a positive displacement pump is fed through a mixing valve comprising two valves having a common actuator; and

FIG. 3 is a flow diagram for the control of the closed loop mixing system in an embodiment where a positive displacement pump is fed through a mixing valve comprising two valves having separate actuators.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

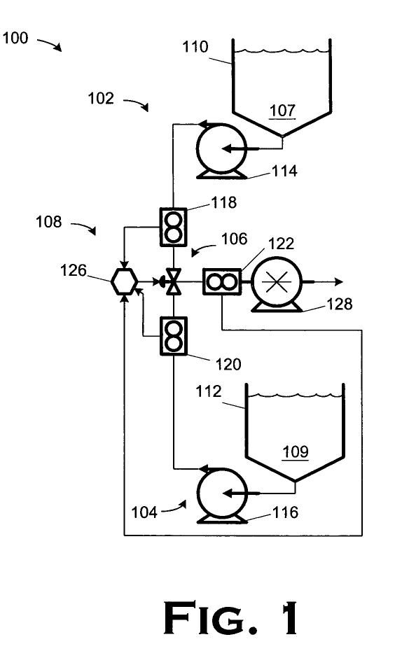

FIG. 1 illustrates a mixing apparatus 100 constructed and operated in accordance with one particular embodiment of the present invention. The apparatus 100 includes a first fluid feed 102, a second fluid feed 104, a mixing valve 106, and a closed control system 108. The mixing valve 106 is capable of mixing a first fluid 107 received from the first fluid feed 102 and a second fluid 109 received from the second fluid feed 104 to produce a mixed fluid (not shown). The closed control system 108 is capable of controlling the mixing valve 106 to determine the ratio of the first and second fluids 107, 109 in the mixed fluid while maintaining the pressure of the mixed fluid at a predetermined level.

More particularly, each of the first and second fluid feeds 102, 104 comprises a holding tank 110, 112, respectively, and a pump 114, 116, respectively, capable of pumping the respective fluid 107, 109 from the holding tanks 110, 112, to the mixing valve 106. Note that it is not necessary to the practice of the invention that the first and second fluid feeds 102, 104 have the same construction. In alternative embodiments, the first and second fluid feeds 102, 104 may be implemented using different kinds and numbers of equipment.

The implementation of the first and second fluid feeds 102, 104 will be strongly influenced by the properties of the first and second fluids 107, 109. For instance, in the illustrated embodiment, the first fluid 107 is water (H₂O) and the second fluid 109 is a raw acid. More particularly, the second fluid 109 is hydrochloric acid (HCl). As those skilled in the art having the benefit of this disclosure will appreciate, different materials behave differently in the presence of these two different fluids. Different equipment will therefore typically be desired to handle these two fluids. In some embodiments, the differences between the properties of the two fluids may even be more subtle—for instance, the difference between tap water and sea water. Thus, the implementation of the first and second fluid feeds 102, 104 will depend somewhat on the properties of the first and second fluids 107, 109.

In the embodiment illustrated in FIG. 1, the pumps 114, 116 are centrifugal pumps. Suitable centrifugal pumps are well known to the art. Exemplary, commercially available, off-the shelf centrifugal pumps suitable for implementing the pump 114 (i.e., the water service) include:
Crane Deming Model 5064 8″×6″-17″ Impeller
Mission Magnum 10″×8″-14″ Impeller
   Exemplary, commercially available, off-the shelf centrifugal pumps suitable for implementing the pump 116 (i.e., the acid service) include:
ITT Goulds Model 3298 6″×4″-10″ Impeller
Innomag TBMAG-C 4″×3″-8″ Impeller
   However, any suitable centrifugal pump known to the art may be used.

The holding tanks 110, 112 also should be implemented keeping the properties of the first and second fluids 107, 109 in mind. As those in the art having the benefit of this disclosure will appreciate, there are many makes and models of holding tanks that are commercially available. The selection will be readily apparent to those in the art once the implementation-specific details for the system have been developed. These implementation specific details will include not only the properties of the first and second fluids 107, 109, but also storage capacities, flow rates, size constraints, etc. In the illustrated embodiment, the holding tank 110 (i.e., for the water service) may be implemented with standard frac tanks, ship's below deck mud tanks, body of water, or other. The holding tank 112 (i.e., for the acid service) may be implemented with a 40,000 gallon acid storage tank with appropriated liner, or with a natural rubber lined, 150 bbl tank 8′ diameter with a 6″ suction.

The mixing valve 106 is a three-way valve. In the illustrated embodiment, the mixing valve 106 is implemented by a pair of valves (not otherwise shown) slaved together with a common actuator such that as one of the valves opens the other closes. In one particular implementation, the mixing valve 106 may be implemented with two stream selector valves:
a CHEMVALVE 2-4″-790-150-PPL/PPL/V-PORT-T/PPL-SLAVE C/W
DANFOSS BRC-012 ACTUATOR AND STONEL POSITION
TRANSMITTER PQ70EIC valve, and
a CHEMVALVE 2-6″-790-150-PPL/PPL/V-PORT-T/PPL-SLAVE C/W
DANFOSS BRC-012 ACTUATOR AND STONEL POSITION
TRANSMITTER PQ70EIC valve.
   Other suitable, separate actuated valves that may be used include:
Norris Butterfly Valve 4″ R1010-43AA-1A valve; and
Dezurik V-Port Ball Valve 8″ VPB8F1SCSTCS3NH-S10-RT-FT
CHEMVALVE V-Port Plug Valve 6″ 790-150 valve.
   However, other suitable valves may be employed. Other actuation arrangements may also be employed. For instance, the mixing valve may be implemented with a pair of valves separately actuated, but slaved together by the electronic controller 126 such that as one valve opens the other closes and vice versa.

As previously mentioned, the control system 108 in FIG. 1 is a closed system. The control system 108 may be closed in a variety of ways. For instance, the control system 108 may be closed by a measuring device (not shown) measuring a selected characteristic of the mixed fluid, by the ratio of two inlet flow meters, by a discharge flow meter and one inlet flow meter. If a measuring device is used, the measuring device might be, for instance, a pH meter (not shown) measuring the pH of the mixed fluid or a density meter (not shown) measuring the density of the mixed fluid. In the illustrated embodiment, the control system 108 is closed by a discharge flow meter and one inlet flow meter, as is discussed more fully immediately below.

The control system 108 of the illustrated embodiment includes an inlet flow meter 118 on the first fluid feed 102, an inlet flow meter 120 on the second fluid feed 104, an outlet flow meter 122 on the outlet of the mixing valve 106, and an electronic controller 126. The implementation of the inlet flow meters 118, 120 and the outlet flow meter 122 should, like the pumps 114, 116, consider the properties of the first and second fluids. As noted, in the illustrated embodiment, the first fluid is water and the second fluid is an acid. Accordingly, the flow meters 118, 120, 122 may be implemented with:
for the acid service, a 6″ Rosemount 8707 Magnetic Flowmeter Teflon Lined Hasteloy Electrodes 8705-T-H-A-060-X1-L1 meter;
for the water service, a 6″ Rosemount 8705 Magnetic Flowmeter Poly Lined 8705PXA060C1W1NAF0220 meter; and
for the mixed fluid, a 6″ Rosemount 8705 Magnetic Flowmeter Teflon Lined Hasteloy Electrodes 8705-T-H-A-060-X1-L1 meter.
   Again, however, other suitable flow meters known to the art may be employed in alternative embodiments.

The electronic controller 126 is a Proportional, Integral, Differential (“PID”) controller. In one particular implementation is a controller disclosed and claimed in U.S. Pat. No. 6,007,227, entitled “Blender Control System,” and issued Dec. 28, 1999, to BJ Services Co. as assignee of the inventor Bradley T. Carlson. Alternative embodiments may employ other PID controllers. Exemplary, commercially available PID controllers that may be employed in various embodiments include a Programmable Logic Controller (“PLC”) type controller from Homer Electric Co. operating on the Homer Electric Operator Control Station (“OCS”) Control System and comprising a base CPU (Part No. HE800FOX104), a Universal I/O Module (Part No. HE800MIX904), and a Color Display Module (Part No. HE800MIX904). However, still other PID controllers may be used.

The illustrated embodiment also includes a positive displacement pump 128 on the outflow of the mixing valve 106. The positive displacement pump 128 may be implemented using any such pump known to the art that is suitable for a given system's design. Suitable positive displacement pumps include the:
SPM QWS2500 pump (a Quintuplex pump); and
SPM TWS2000 pump (a Triplex pump).
   However, other suitable positive displacement pumps may be used.

In operation, the positive displacement pump 128 pumps the mixed fluid received from the mixing valve 106 to, for example, a well used in hydrocarbon prospecting or production. The mixing valve 106, as mentioned above, controls the ratio of the first and second fluids 107, 109 in the mixed fluid under the programmed control of the electronic controller 126. The ratio may range from a 100% ratio of the first fluid 107, through a 50%-50% ratio of the first fluid 107 to the second fluid 109, to a 100% ratio of the second fluid 109. The ratio may also vary over time, depending on the programming of the electronic controller 126. The positive displacement pump 128 controls the flow rates of the first and second fluids in the first and second fluid feeds 102, 104.

In the embodiment of FIG. 1, the electronic controller 126 is programmed with the desired ratio of the first and second fluids 107, 109. The electronic controller 126 receives flow rate data from the flow meters 118, 120, 122, and from that information indirectly determines the actual ratio of the first and second fluids 107, 109 in the mixed fluid. Because one side of the mixing valve 106 closes as the other opens, one or the other of the first and second fluids 107, 109—and typically both—is fed to the positive displacement pump 128 whenever it is operating. Thus, the closed control system 108 is capable of controlling the mixing valve 106 to determine the ratio of the first and second fluids 107, 109 in the mixed fluid while maintaining the pressure of the mixed fluid at a predetermined level.

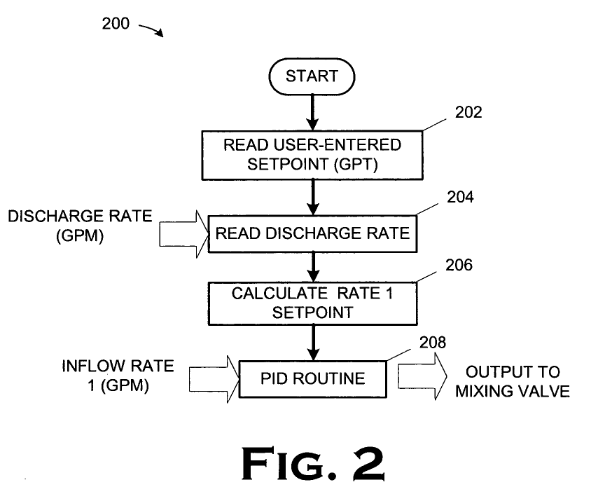

FIG. 2 is a flow diagram 200 for the control of the closed loop mixing system 100 in an embodiment where a positive displacement pump 128 is fed through a mixing valve 106 comprising two valves (not otherwise shown) having a common actuator. The control process begins (at 202) by reading the user-entered setpoint. The setpoint is the desired ratio of the first fluid 107 to the discharge rate 122, is typically measured in gallons-per-thousand (“gpt”), and is typically entered on a keypad (not shown) for the electronic controller 126.

The electronic controller 126 then reads (at 204) the discharge rate of the mixed fluid from the mixing valve 106. The discharge rate is measured by the outlet flow meter 122, from which the electronic controller 126 receives the measured discharge rate as an input. The discharge rate is typically measured in gallons-per-minute (“gpm”).

In the illustrated embodiment, the electronic controller 126 then calculates (at 206) the Rate 1 (i.e., the flow rate of the first fluid) setpoint in gallons-per-minute for the first fluid 107. The illustrated embodiment calculates as follows:
Rate 1 Setpoint=1,000÷Discharge Rate*Setpoint (GPT)
This calculation converts the units of measurement from those entered by the user to those measured by the outlet flow meter 122. Note that this is driven by the units of measurement being used, and is therefore implementation specific. If the setpoint is entered in the same units of measurement employed by the outlet flow meter 122, then this conversion can be omitted. Thus, not all embodiments will include this calculation.

The electronic controller 126 then (at 208) determines from the inflow rate of the first fluid 107 measured by the inlet flow meter 118 the output to the mixing valve 106. Note that the inflow rate is measured, in the illustrated embodiment, in gallons-per-minute. Note also that alternative embodiments may employ the inflow rate of the second fluid 109 measured by the inlet flow meter 120. The determination is made by a PID routine (not otherwise shown) in the electronic controller 126, and is therefore also implementation specific. The output to the mixing valve 106 is an electronic signal that drives the actuator of the mixing valve 106. Thus, the PID routine compares the inflow rate to the setpoint, determines whether the mixing valve 106 needs to be adjusted, and generates the output to the mixing valve 106 to adjust it appropriately should adjustment be needed.

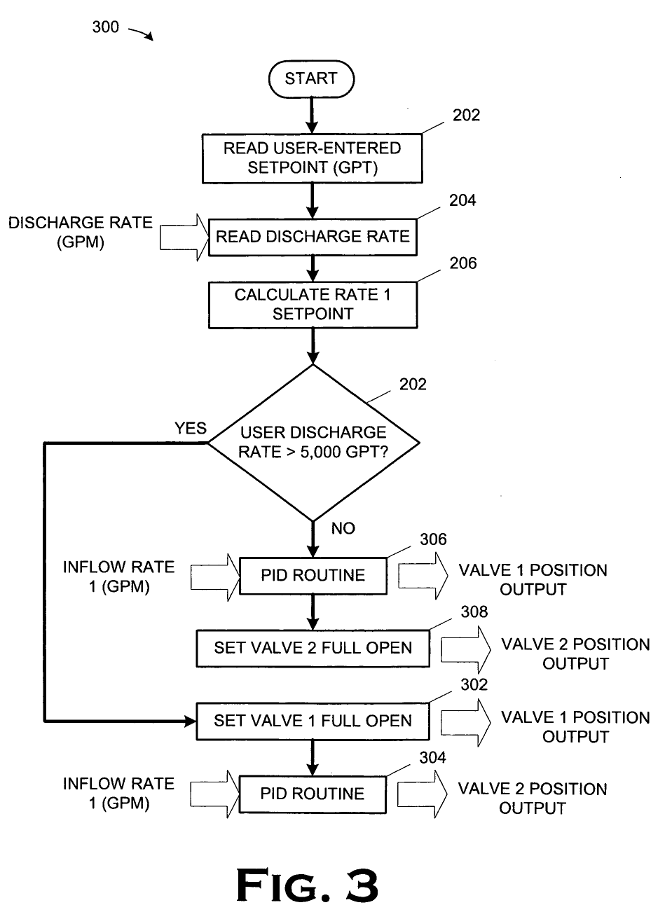

FIG. 3 is a flow diagram 300 for the control of the closed loop mixing system 100 in an embodiment where the positive displacement pump 128 is fed through a mixing valve 106 comprising two valves (not otherwise shown) having separate actuators. The flow diagram 300 begins similarly to the flow diagram 200 in FIG. 2. However, the calculation of the Rate 1 setpoint (at 206) in gpm is slightly different:
SPGPM=1,000÷Discharge Rate*SPGM
After the setpoint is calculated (at 206), the flow diagram 300 determines whether the user discharge rate (i.e., the user-entered setpoint) is greater than 5,000 gpt.

If the user-enters a rate>5,000 gpt, then the electronic controller 126 sets (at 302) the valve for the first fluid feed 102 (“valve 1”) full open. The PID routine then determines (at 304) from the inflow rate of the first fluid feed 102 (measured by the inlet flow meter 118) and sets the valve for the second fluid feed 104 (“valve 2”). If the user enters a rate<5,000 gpt, the PID routine determines (at 306) from the inflow rate of the first fluid feed 102 (measured by the inlet flow meter 118) and sets the valve for the first fluid feed 102 (“valve 1”). The electronic controller 126 then sets the valve for the second fluid feed 104 (“valve 2”) full open.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. An apparatus, comprising:
a first pressurized fluid feed;
a second pressurized fluid feed;
a mixing valve capable of mixing a first pressurized fluid received from the first pressurized fluid feed and a second pressurized fluid received from the second pressurized fluid feed to produce a mixed fluid; and
a closed control system capable of controlling the mixing valve to determine the ratio of the first and second pressurized fluids in the mixed fluid while maintaining the pressure of the mixed fluid above a predetermined minimum level.

2. The apparatus of claim 1, wherein at least one of the first and second pressurized fluid feeds includes:
a holding tank; and
a pump capable of pumping the respective pressurized fluid from the holding tank to the mixing valve.

3. The apparatus of claim 1, wherein the mixing valve comprises a three-way valve.

4. The apparatus of claim 1, wherein the mixing valve comprises a pair of valves slaved together with a common actuator such that as one of the valves opens the other closes.

5. The apparatus of claim 1, wherein the mixing valve comprises a pair of valves separately actuated, but slaved together by the closed control system such that as one valve opens the other closes and vice versa.

6. The apparatus of claim 1, wherein the closed control system includes:
a first flow meter capable of measuring the flow of the first pressurized fluid to the mixing valve;
a second flow meter capable of measuring the flow of the second pressurized fluid to the mixing valve; and
an electronic controller capable of actuating the mixing valve responsive to the measured flows of the first and second pressurized fluids to determine the ratios of the first and second pressurized fluids in the mixed fluid.

7. The apparatus of claim 6, wherein the closed control system further includes at least one of a measuring device measuring a selected characteristic of the mixed fluid and a third flow meter measuring the flow of the mixed fluid in conjunction with one of the first and second flow meters.

8. The apparatus of claim 7, wherein the measuring device is a density meter measuring the density of the mixed fluid.

9. The apparatus of claim 1, further comprising a positive displacement pump capable of pumping the mixed fluid.

10. The apparatus of claim 9, wherein the closed control system includes:
a first flow meter capable of measuring the flow of the first pressurized fluid to the mixing valve;
a second flow meter capable of measuring the flow of the second pressurized fluid to the mixing valve;
a third flow meter capable of measuring the flow of the mixed fluid pumped by the positive displacement pump; and
an electronic controller capable of actuating the mixing valve responsive to the measured flows of the first and second pressurized fluids to determine the ratios of the first and second pressurized fluids in the mixed fluid and responsive to the flow of the mixed fluid to the positive displacement pump to maintain a positive feed pressure to the positive displacement pump.

11. The apparatus of claim 1, wherein the closed control system includes at least one of:
a measuring device measuring a selected characteristic of the mixed fluid; and
a discharge flow meter capable of measuring the flow of the mixed fluid in conjunction with an inlet flow meter capable of measuring the flow of one of the first and second pressurized fluids to the mixing valve.

12. The apparatus of claim 11, wherein the measuring device is a density meter capable of measuring the density of the mixed fluid.

13. An apparatus, comprising:
first means for feeding fluid;
second means for feeding fluid;
means for mixing a first fluid received from the first fluid feeding means and a second fluid received from the second fluid feeding means to produce a mixed fluid; and
means for controlling the mixing means to determine the ratio of the first and second fluids in the mixed fluid while maintaining the pressure of the mixed fluid at a predetermined level.

14. The apparatus of claim 13, wherein at least one of the first and second fluid feeding means includes:
means for holding a fluid; and
means for pumping the respective fluid from the holding means to the mixing means.

15. The apparatus of claim 13, wherein the mixing means comprises a three-way valve.

16. The apparatus of claim 13, wherein the mixing means comprises a pair of valves slaved together with a common actuator such that as one of the valves opens the other closes.

17. The apparatus of claim 13, wherein the mixing means comprises a pair of valves separately actuated, but slaved together by the controlling means such that as one valve opens the other closes and vice versa.

18. The apparatus of claim 13, wherein the controlling means includes:
first means for measuring the flow of the first fluid to the mixing means;
second means for measuring the flow of the second fluid to the mixing means; and
means for actuating the mixing means responsive to the measured flows of the first and second fluids to determine the ratios of the first and second fluids in the mixed fluid.

19. The apparatus of claim 18, wherein the controlling means further includes at least one of a means for measuring a selected characteristic of the mixed fluid and a third means for measuring the flow of the mixed fluid in conjunction with one of the first and second flow measuring means.

20. The apparatus of claim 19, wherein the measuring means is a means for measuring the density of the mixed fluid.

21. The apparatus of claim 13, further comprising means for pumping the mixed fluid.

22. The apparatus of claim 21, wherein the controlling means includes:
first means for measuring the flow of the first fluid to the mixing means;
second means for measuring the flow of the second fluid to the mixing means;
third means for measuring the flow of the mixed fluid pumped by the pumping means; and
means for actuating the mixing means responsive to the measured flows of the first and second fluids to determine the ratios of the first and second fluids in the mixed fluid and responsive to the flow of the mixed fluid to the pumping means to maintain a positive feed pressure to the pumping means.

23. The apparatus of claim 13, wherein the controlling means includes at least one of:
means for measuring a selected characteristic of the mixed fluid; and
means for measuring the flow of the mixed fluid in conjunction with a means for measuring the flow of one of the first and second fluids to the mixing means.

24. The apparatus of claim 23, wherein the means for measuring the selected characteristic is:
means for measuring the density of the mixed fluid.

25. A method, comprising:
feeding a first pressurized fluid to a mixing valve;
feeding a second pressurized fluid to the mixing valve;
mixing the first and second pressurized fluids in the mixing valve; and
controlling the actuation of the mixing valve to determine the ratio of the first and second pressurized fluids in a resultant mixed fluid while maintaining the pressure of the mixed fluid at a predetermined level.

26. The method of claim 25, wherein feeding at least one of the first and second pressurized fluid feeds includes pumping the respective pressurized fluid from a holding tank to the mixing valve.

27. The method of claim 25, wherein the controlling the actuation of the mixing valve includes slaving a pair of valves with a common actuator such that as one opens the other closes.

28. The method of claim 25, wherein controlling the actuation of the mixing valve includes:
measuring the flow of the first pressurized fluid to the mixing valve;
measuring the flow of the second pressurized fluid to the mixing valve; and
actuating the mixing valve responsive to the measured flows of the first and second pressurized fluids to determine the ratios of the first and second pressurized fluids in the mixed fluid.

29. The method of claim 28, wherein controlling the actuation of the mixing valve includes:
measuring the flow of the mixed fluid pumped by a positive displacement pump; and
actuating the mixing valve responsive to the flow of the mixed fluid to the positive displacement pump to maintain a positive feed pressure to the positive displacement pump.

30. The method of claim 25, wherein maintaining the pressure of the mixed fluid at the predetermined level includes at least one of:
measuring a selected characteristic of the mixed fluid; and
measuring the flow of the mixed fluid in conjunction with measuring the flow of one of the first and second pressurized fluids to the mixing valve.

31. The method of claim 30, wherein measuring the selected characteristic includes:
measuring the density of the mixed fluid.

32. The apparatus of claim 1, wherein at least one of the first and second pressurized fluids is a fluid used in hydrocarbon exploration or hydrocarbon production.

33. The apparatus of claim 13, wherein at least one of the first and second fluid feeding means is a means for feeding a fluid used in hydrocarbon exploration or hydrocarbon production.

34. The method of claim 25, wherein at least one of the feeding the first pressurized fluid and feeding the second pressurized fluid includes feeding a fluid used in hydrocarbon exploration or hydrocarbon production.

35. The apparatus of claim 7, wherein the measuring device is a pH meter measuring the pH of the mixed fluid.

36. The apparatus of claim 11, wherein the measuring device is a pH meter capable of measuring the pH of the mixed fluid.

37. The apparatus of claim 19, wherein the measuring means is a means for measuring the pH of the mixed fluid.

38. The apparatus of claim 23, wherein the means for measuring the selected characteristic is a means for measuring the pH of the mixed fluid.

39. The method of claim 30, wherein measuring the selected characteristic includes measuring the pH of the mixed fluid.

40. An apparatus, comprising:
a water service capable of feeding water under pressure;
an acid service capable of feeding acid under pressure;
a mixing valve capable of mixing the water and the acid to produce a mixed fluid for use in hydrocarbon production; and
a closed control system capable of controlling the mixing valve to determine the ratio of the water and acid in the mixed fluid while maintaining the pressure of the mixed fluid above a predetermined minimum level.

41. The apparatus of claim 40, wherein pressurized water feed includes:
a frac tank; and
a centrifugal pump capable of pumping the water from the frac tank to the mixing valve.

42. The apparatus of claim 40, wherein pressurized acid feed includes:
an acid storage tank; and
a centrifugal pump capable of pumping the acid from the acid storage tank to the mixing valve.

43. The apparatus of claim 40, wherein the mixing valve comprises a three-way valve.

44. The apparatus of claim 40, wherein the closed control system includes:
a first flow meter capable of measuring the flow of the first pressurized fluid to the mixing valve;
a second flow meter capable of measuring the flow of the second pressurized fluid to the mixing valve; and
a proportional, integral, differential controller capable of actuating the mixing valve responsive to the measured flows of the first and second pressurized fluids to determine the ratios of the first and second pressurized fluids in the mixed fluid.

45. The apparatus of claim 40, further comprising a positive displacement pump capable of pumping the mixed fluid.
